(19) United States
(12) Patent Application Publication
(10) Pub. No.: US 2019/0215837 A1
(43) Pub. Date: Jul. 11, 2019

(54) SECURE AND DISTRIBUTED DFS BETWEEN HOST AND FIRMWARE

(71) Applicant: QUALCOMM Incorporated, San Diego, CA (US)

(72) Inventors: Rohan DUTTA, Kolkata (IN); Abhijit PRADHAN, Chennai (IN); Shashikala Prabhu BAILA, Mangalore (IN)

(21) Appl. No.: 15/867,336

(22) Filed: Jan. 10, 2018

(51) Int. Cl. H04W 72/04; H04W 72/08; H04L 29/08; H04L 5/00; H04W 72/02

(52) U.S. Cl. CPC H04W 72/0486; H04W 72/082; H04L 67/1008; H04L 43/16; H04W 72/02; H04W 72/0453; H04L 5/0062

(57) ABSTRACT

Aspects of the disclosure provide techniques for a secure distributed dynamic frequency selection (DFS) scheme. In an aspect, the disclosure describes a method, device, and computer-readable medium in which DFS filtering is configured in each of a host software executable on a host processor and a firmware executable on a target processor on a single wireless communications device. The DFS filtering is initially (or by default) performed by the firmware. The firmware may then monitor a target load metric of the target processor to identify conditions that may indicate that the target processor is overloaded. Based on the monitoring, the firmware may determine whether to move the DFS filtering from being performed by the firmware to being performed by the host software (if deemed secure). The firmware may also move the DFS filtering back to being performed by the firmware if conditions at the target processor improve.

### BACKGROUND

The deployment of wireless local area networks (WLANs) in the home, the office, and various public facilities is commonplace today. Such networks typically employ a wireless access point (AP) that connects a number of wireless devices or stations (STAs) in a specific locality (e.g., home, office, public facility, etc.) to another network, such as the Internet or the like. A set of STAs can communicate with each other through a common AP in what is referred to as a basic service set (BSS).

In WLANs and similar IEEE 802.11-compliant networks, Dynamic Frequency Selection or DFS is a mechanism that allows wireless devices (e.g., STAs) to use 5 GHz frequency bands or channels without causing interference to radar systems or other services that are allocated in those channels. In an example, there may be multiple 20 MHz channels available at 5 GHz and DFS may apply to a subset of those channels. In general, DFS is used to have the wireless device dynamically detect the presence of signals from a radar system on a channel that the wireless device is using or intends to use. If the level of the signals associated with the radar system is above a certain threshold the wireless device is to select an alternative channel for wireless communications. That is, DFS allows the wireless device to automatically select frequency channels with low interference levels.

In one scenario, it is possible that code or algorithms used with DFS in a wireless device may be interfered, tampered, or otherwise altered without authorization in order to override the radar avoidance functionality of DFS. In another scenario, if the wireless device were to enter into a power save mode or sleep mode, a host processor in the wireless device may not be able to perform DFS (e.g., may not process radar signals or pulses) without first needing to wake up the wireless device, making DFS unavailable during the time the wireless device is in the power save mode or sleep mode.

As such, it is desirable to provide techniques that enable DFS to be not only secure but also available during various operational scenarios.

### SUMMARY

Aspects of the disclosure address a secure distributed DFS between a host (e.g., a host software) and firmware (e.g., target software). The following description and the annexed drawings set forth in detail certain illustrative features of the one or more aspects. These features are indicative, however, of but a few of the various ways in which the principles of various aspects may be employed, and this description is intended to include all such aspects and their equivalents.

In an aspect, a method for distributed DFS is described that includes configuring or enabling DFS filtering (e.g., DFS pulse/signal filtering) in each of a host software executable on a host processor and a firmware executable on a target processor, where the DFS filtering is performed initially (or by default) by the firmware. The method also includes monitoring a target load metric associated with the target processor, and determining, by the firmware, whether to move the DFS filtering from being performed by the firmware to being performed by the host software based at least in part on the monitoring. The target load metric may indicate a level of utilization of the target processor (e.g., percentage of processing cycles being used by the target processor).

In another aspect, a wireless communications device for DFS is described that includes a memory storing instructions, and one or more processors (e.g., central processing units or CPUs) including a target processor. The processors may be configured to configure or enable DFS filtering (e.g., DFS pulse/signal filtering) in each of a host software executable on a host processor and a firmware executable on the target processor, where the DFS filtering is performed initially (or by default) by the firmware. The processors may also be configured to monitor a target load metric associated with the target processor, and determine, by the firmware, whether to move the DFS filtering from being performed by the firmware to being performed by the host software based at least in part on the monitoring. The target load metric may indicate a level of utilization of the target processor (e.g., percentage of processing cycles being used by the target processor).

In another aspect, a computer-readable medium storing code executable by one or more processors for DFS is described that includes code for configuring or enabling DFS filtering (e.g., DFS pulse/signal filtering) in each of a host software executable on a host processor and a firmware executable on a target processor, where the DFS filtering is performed initially (or by default) by the firmware. The computer-readable medium may also include code for monitoring a target load metric associated with the target processor, and code for determining, by the firmware, whether to move the DFS filtering from being performed by the firmware to being performed by the host software based at least in part on the monitoring. The target load metric may indicate a level of utilization of the target processor (e.g., percentage of processing cycles being used by the target processor).

Each of the aspects described above can also be implemented using means for performing the various functions described in connection with those aspects.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a conceptual diagram illustrating an example of a wireless local area network (WLAN) deployment in accordance with various aspects of the disclosure;

FIG. 2A is a block diagram illustrating an example of a wireless communications device with a WLAN card in accordance with various aspects of the disclosure;

FIG. 2B is a block diagram illustrating an example of a secure and distributed DFS scheme in accordance with various aspects of the disclosure;

FIG. 3A is a schematic illustrating an example of load balancing between a host software and a target software/firmware in accordance with various aspects of the disclosure;

FIG. 3B is a schematic illustrating another example of load balancing between a host software and a target software/firmware in accordance with various aspects of the disclosure;

FIG. 4 is a flow diagram illustrating an example of a method for a secure and distributed DFS in accordance with various aspects of the disclosure;

FIG. 5 is a flow diagram illustrating an example of another method for a secure and distributed DFS in accordance with various aspects of the disclosure; and

FIG. 6 is a schematic diagram illustrating an example of various components in a wireless station (STA) in accordance with various aspects of the disclosure.

### DETAILED DESCRIPTION

The disclosure describes techniques for a secure and distributed DFS between a host (e.g., a host software) and firmware (e.g., target software) in a wireless device. These techniques may be implemented as methods, apparatuses, computer-readable media, and means for secure and distributed DFS. The terms DFS, DFS mechanism, DFS scheme, DFS processing, and DFS filtering may be used interchangeably to refer to operations, algorithms, and/or functions associated with processing (e.g., filtering) of signals or pulses to detect the presence of a radar system (or similar systems) by identifying characteristics or signatures found in radar-generated transmissions. When the presence of a radar system is detected in a particular frequency channel, the wireless device may in turn select alternative frequency channels that avoid interfering with the radar system. The signals or pulses processed by DFS may be referred to as DFS signals or DFS pulses.

As described above, there may be scenarios in which code or algorithms used to perform DFS in a wireless device may be interfered, tampered, or otherwise altered without authorization in order to override the radar avoidance functionality of DFS. Accordingly, the disclosure describes techniques to provide a secure and distributed DFS that may avoid or overcome any tampering of DFS code or algorithms that are executed on a host processor in the wireless device.

Also described above are scenarios in which a wireless device may enter into a power save mode or sleep mode and a host processor in the wireless device may not be able to perform DFS (e.g., may not process radar signals or pulses) without first having to wake up the wireless device. Accordingly, the disclosure describes techniques to provide a secure and distributed DFS in which DFS may be migrated from firmware executing on a target processor (e.g., a processor in a WLAN card in the wireless device) to the host processor when the target processor is heavily loaded (e.g., high utilization of processing or CPU cycles of the target processor), and where DFS may be migrated to the firmware executing on the target processor when the target processor is lightly loaded (e.g., low utilization of processing or CPU cycles of the target processor) and/or when the wireless device has entered into a power save mode or a sleep mode and the host processor would not be able to handle DFS making DFS unavailable during the power save mode or sleep mode.

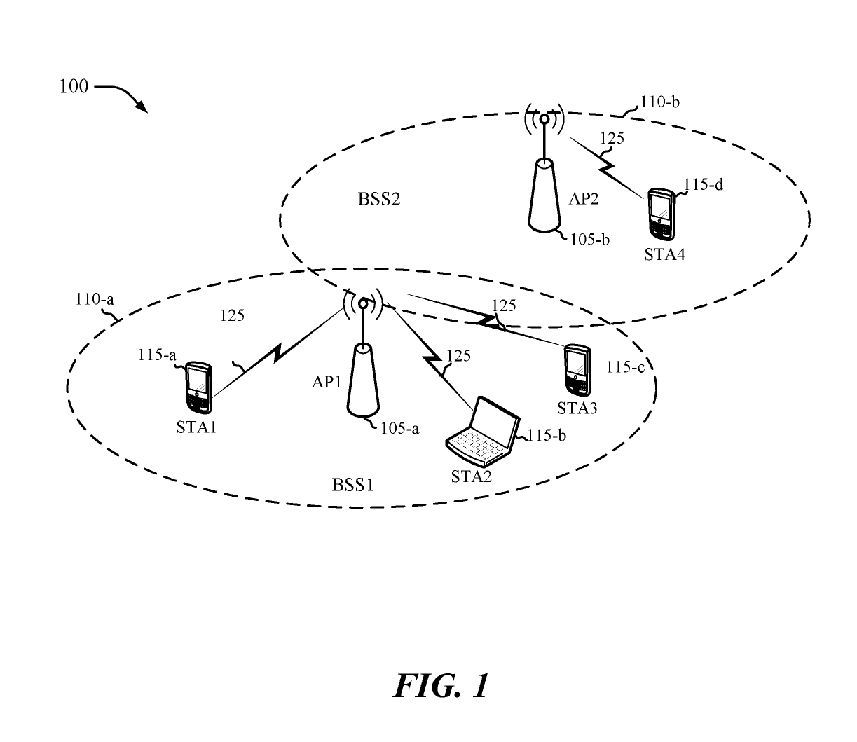

Various aspects are now described in more detail with reference to the FIGS. 1- 6. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components or subcomponents.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Although the various aspects or techniques provided in this disclosure related to secure and distributed DFS are generally described in connection with a wireless device (or wireless communications device) such as a wireless station (STA), the disclosure is not so limited and the same or similar aspects or techniques may also apply to other types of wireless devices such as access points (APs).

FIG. 1 is a conceptual diagram 100 illustrating an example of a WLAN deployment in connection with various techniques described herein, including various aspects described in connection with secure and distributed DFS. The WLAN deployment may include one or more access points (APs) and one or more stations (STAs) associated with a respective AP. One or more of the STAs may support the techniques described herein for secure and distributed DFS.

In the example of FIG. 1, there are two APs deployed: AP1 105-a in basic service set 1 (BSS1) and AP2 105-b in BSS2, which may be referred to as an overlapping BSS (OBSS). AP1 105-a is shown as having at least three associated STAs (STA1 115-a, STA2 115-b, STA3 115-c) and coverage area 110-a, while AP2 105-b is shown having one associated STA4 115-c and coverage area 110-b. The STAs and AP associated with a particular BSS may be referred to as members of that BSS. In the example of FIG. 1, the coverage area of AP1 105-a may overlap part of the coverage area of AP2 105-b such that a STA may be within the overlapping portion of the coverage areas. The number of BSSs, APs, and STAs, and the coverage areas of the APs described in connection with the WLAN deployment of FIG. 1 are provided by way of illustration of a generic WLAN deployment and not of limitation.

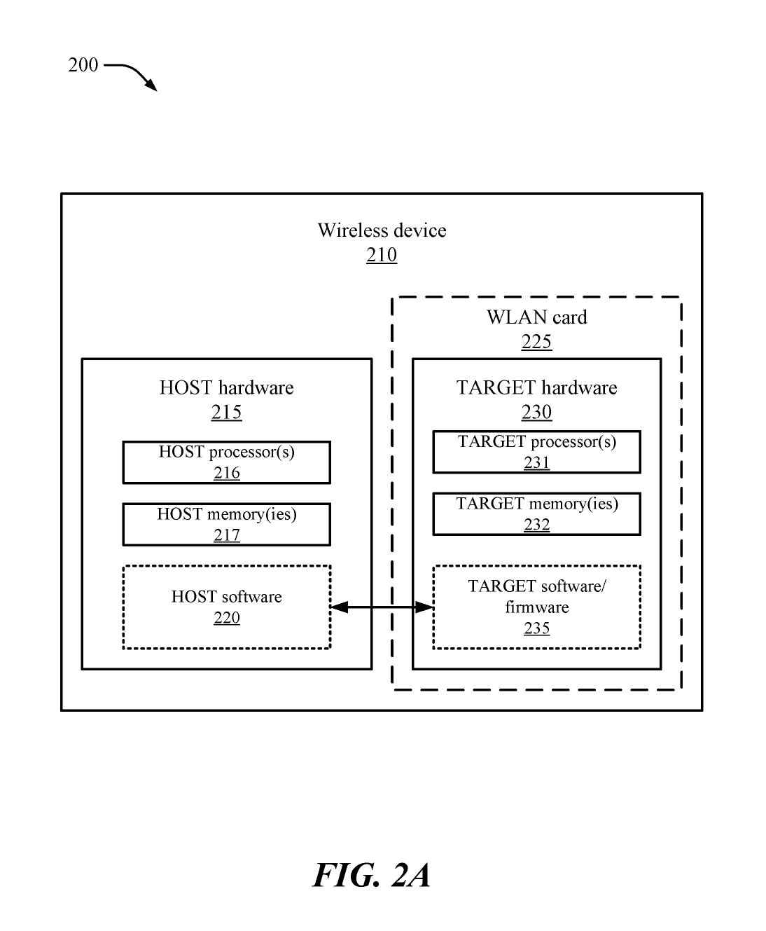

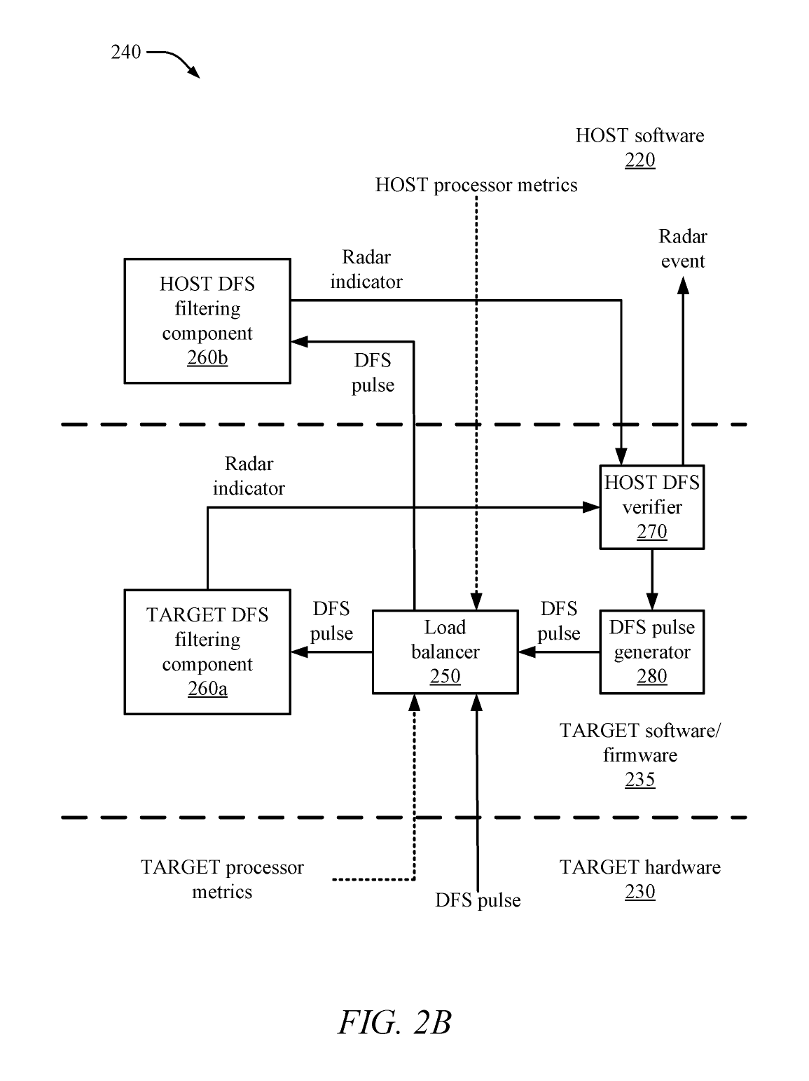

In FIG. 1, the STA2 115-b is shown to be a computer such as a laptop computer, which may include a card (or adapter, controller) to enable WLAN communications (e.g., WLAN card). In such an example, the card may be referred to as a target and may include target hardware such as a target processor and/or a target memory (see e.g., FIG. 2A), for example. Moreover, a remaining portion of the STA2 115-b may be referred to as a host and may include host hardware such as a host processor and/or a host memory (see e.g., FIG. 2A), for example, which may be separate from the target processor and/or the target memory in the card or target. By using a card or target, it is possible for the STA2 115-b to distribute DFS between the host and the card by having DFS capabilities in both the host and the card.

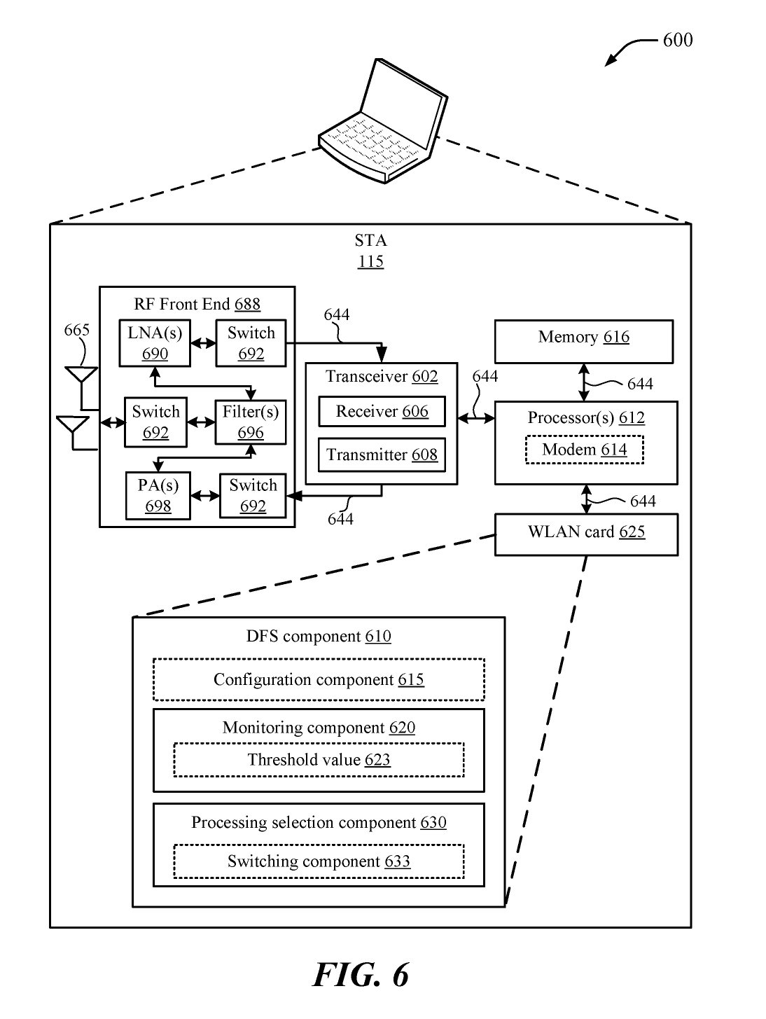

An STA in FIG. 1, such as the STA2 115-b, for example, may include multiple processors (e.g., a host processor and a target processor in a WLAN card or target) that enable the implementation of a DFS component 610 as described in more detail below in FIG. 6. The DFS component 610 may be configured to perform operations or functions associated techniques for a secure and distributed DFS.

In some examples, the APs (e.g., AP1 105-a and AP2 105-b) shown in FIG. 1 are generally fixed terminals that provide backhaul services to STAs 115 within its coverage area or region. In some applications, however, the AP may be a mobile or non-fixed terminal. The STAs (e.g., STA1 115-a, STA2 115-b, STA3 115-c, STA4 115-d) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer (see e.g., STA2 115-b), a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature. Moreover, and as noted above, any features described for secure and distributed DFS in the context of an STA may also apply in the context of an AP.

Each of STA1 115-a, STA2 115-b, STA3 115-c, STA4 115-d may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications link 125. The APs can send frames or packets to their respective STAs and receive frames or packets from their respective STAs to communicate data and/or control information (e.g., signaling).

Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link 125 may be established between the AP 105 and the STA 115 such that the AP 105 and the associated STA 115 may exchange frames or messages through a direct communications channel. It should be noted that the wireless communication system, in some examples, may not have a central AP (e.g., AP 105), but rather may function as a peer-to-peer network between the STAs. Accordingly, the functions of the AP 105 described herein may alternatively be performed by one or more of the STAs 115. Such systems may be referred to as an “ad-hoc” communication systems in which terminals asynchronously communication directly with each other without use of any specific AP referred to as an IBSS or mesh. Features of the disclosure may be equally adaptable in such “ad-hoc” communication system where a broadcasting STA 115 function as the transmitting device of the plurality of multicast frames in lieu of the AP 105.

While aspects of the disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing a secure and distributed DFS mechanism may be applicable to any suitable wireless network regardless of the coverage range and the wireless access protocols utilized.

In some aspects, one or more APs (105-a and 105-b) may transmit on one or more channels (e.g., multiple narrowband channels, each channel including a frequency bandwidth) a beacon signal (or simply a “beacon”), via a communications link 125 to STA(s) 115 of the wireless communication system, which may help the STA(s) 115 to synchronize their timing with the APs 105, or which may provide other information or functionality. Such beacons may be transmitted periodically. In one aspect, the period between successive beacon transmissions may be referred to as a beacon interval. Transmission of a beacon may be divided into a number of groups or intervals. In one aspect, the beacon may include, but is not limited to, such information as timestamp information to set a common clock, a peer-to-peer network identifier, a device identifier, capability information, a beacon interval, transmission direction information, reception direction information, a neighbor list, and/or an extended neighbor list, some of which are described in additional detail below. Thus, a beacon may include information that is both common (e.g., shared) amongst several devices and specific to a given device.

FIG. 2A shows a block diagram 200 illustrating an example of a wireless device 210 with a WLAN card 225. The wireless device 210 may be an example of one of the STAs 115 in FIG. 1, such as the STA2 115-b (e.g., a laptop computer).

The wireless device 210 may have a host or host portion/device and a target or target portion/device, the latter of which may correspond to the WLAN card 225. The host may include a host hardware 215, which in turn may include one or more processors (e.g., host processor(s) 216) and/or one or more memories (e.g., host memor(ies) 217). The target may include a target hardware 230, which in turn may include one or more processors (e.g., target processor(s) 231) and/or one or more memories (e.g., target memor(ies) 232).

A host software 220 may be executed on or by the host hardware 215 (e.g., by a host processor 216 in the host hardware). Although not shown, the host software 220 may be executed in connection with a host firmware. In addition, a target software/firmware 235 may be executed on or by the target hardware 230 (e.g., by a target processor 231 in the target hardware). The target software/firmware 235 may be supported by the host software 220. As used in this disclosure, the terms target software, target firmware, and firmware may be used interchangeably, and may be associated with aspects of DFS being performed on the WLAN card 225.

The WLAN card 225 may be communicatively coupled to or integrated with the wireless device 210 and thus with the host hardware 215. In some instances, the WLAN card 225 may be removable. Although not shown, the WLAN card 225 may include its own radio frequency (RF) front end, transceiver, modem, and/or antenna(s), or may share a RF front end, a transceiver, a modem, and/or antennas with other portions of the wireless device 210 (e.g., with the host portion). Examples of an RF front end, a transceiver, a modem, and antennas that may be dedicated to the WLAN card 225 or shared by the WLAN card 225 and other portions of the wireless device 210 are described below in connection with FIG. 6.

FIG. 2B shows a block diagram 240 illustrating an example of a secure and distributed DFS scheme or mechanism. The block diagram 240 describes the distributed nature of the solution being proposed in this disclosure. For example, a target DFS filtering component 260a is implemented, configured, and/or enable in the firmware 235. A host DFS filtering component 260b is implemented, configured, and/or enabled in the host software 220. The target DFS filtering component 260a and the host DFS filtering component 260b have the same functionality, that is, each includes or executes the same functions, logic, and/or algorithms to process DFS pulses or signals to identify characteristics or signatures found in radar-generated transmissions to detect the presence of a radar system on a particular frequency channel. The processing of the DFS pulses may include one or more filtering steps. As such, the terms DFS processing and DFS filtering may be used interchangeably throughout this disclosure. By having the DFS functionality distributed in both the host software 220 and the firmware 235 it is possible to provide both the level of security needed in case of tampering of the host software 220 and also the availability of DFS filtering under different operational scenarios.

Returning to the block diagram 240, one or more DFS pulses (or DFS signals) are received from the target hardware 230 by a load balancer 250. The load balancer 250 is configured to switch or select between having the DFS filtering of the DFS pulses performed by the target DFS filtering component 260a in the firmware 235 and having the DFS filtering of the DFS pulses performed by the host DFS filtering component 260b in the host software 220. To this effect the load balancer 250 may take into consideration target load metrics and/or host load metrics. The target load metrics (also referred to as target CPU load statistics or target processor metrics) may indicate a level of utilization of a target processor (e.g., target processor 231) on which the firmware 235 is being executed. For example, the target load metrics may indicate a percentage of CPU cycles being used. The higher the percentage the higher the load on the target processor, which may limit the ability of the firmware 235 and the target processor to handle the DFS filtering (e.g., by the DFS filtering component 260a).

Similarly, the host load metrics (also referred to as host CPU load statistics or host processor metrics) may indicate a level of utilization of a host processor (e.g., host processor 216) on which the host software 220 is being executed. For example, the host load metrics may indicate a percentage of CPU cycles being used. The higher the percentage the higher the load on the host processor, which may limit the ability of the host software 220 and the host processor to handle the DFS filtering (e.g., by the DFS filtering component 260b).

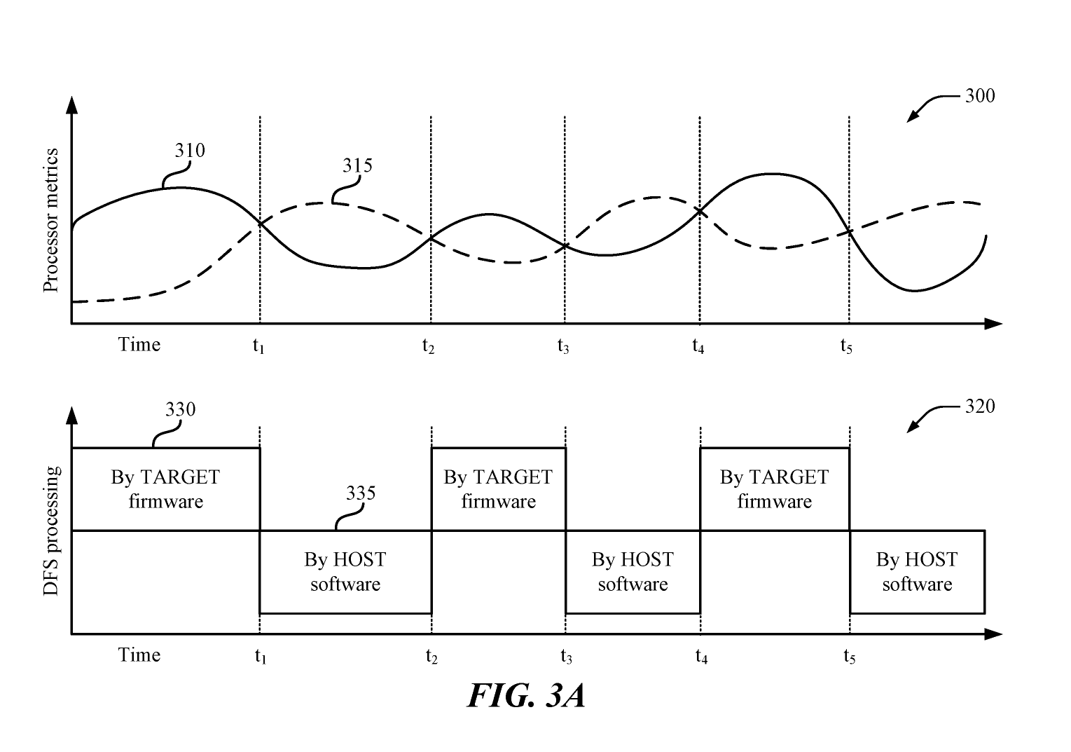

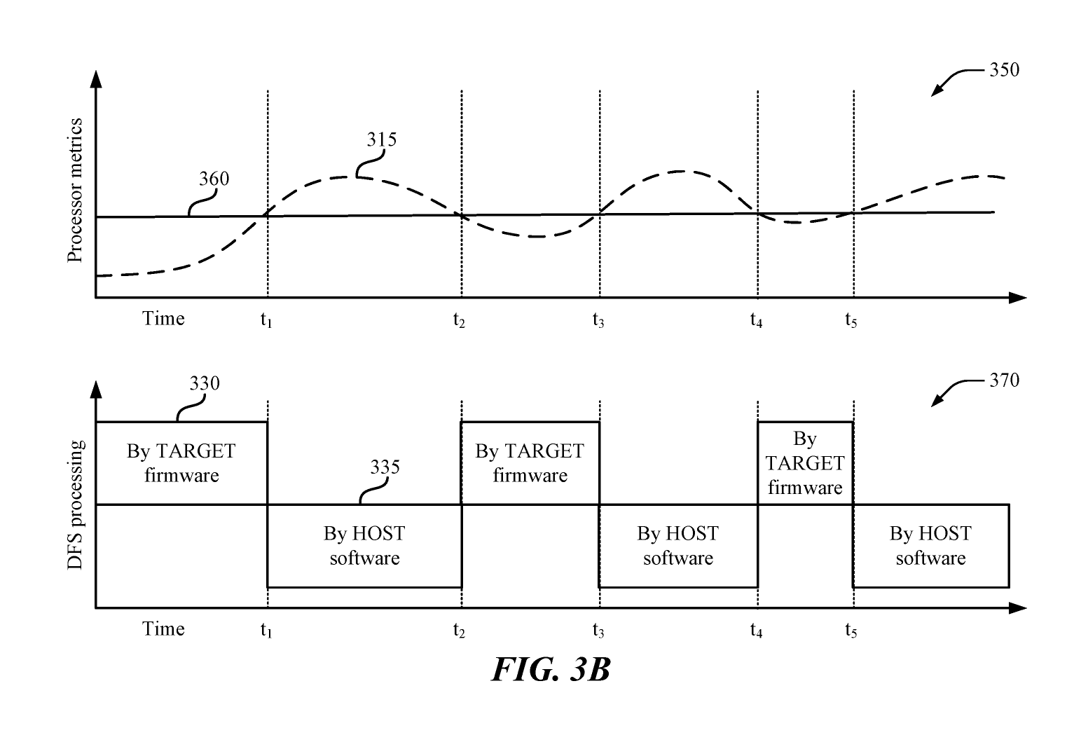

The load balancer 250 may compare the target load metrics to the host load metrics (see e.g., FIG. 3A) or may compare the target load metrics to a threshold value (see e.g., FIG. 3B) to determine whether to have DFS filtering (e.g., processing of DFS pulses) handled by the target DFS filtering component 260a in the firmware 235 or by the host DFS filtering component 260b in the host software 220. In another example, the load balancer 250 may consider a threshold value or an offset when comparing the target load metrics and the host load metrics.

In an aspect, initially or by default, the load balancer 250 may have DFS filtering performed by the target DFS filtering component 260a and may determine, based on various inputs as described above, whether to maintain DFS filtering in the target DFS filtering component 260a or switch DFS filtering to the host DFS filtering component 260b. Moreover, the load balancer 250 may determine, based on various inputs as described above, whether to switch DFS filtering back to the target DFS filtering component 260a from the host DFS filtering component 260b.

The load balancer 250 may direct, route, or send the DFS pulses received from the target hardware 230 to the target DFS filtering component 260a or to the host DFS filtering component 260b based on the selection or switching described above. As described above, each of the target DFS filtering component 260a and the host DFS filtering component 260b is configured to process DFS pulses to identify characteristics or signatures found in radar-generated transmissions to detect the presence of a radar system on a particular frequency channels. If such characteristics or signatures are sufficient (e.g., if a strength level of a pulse or signal associated with a radar-generated transmission is greater than a threshold value), then the target DFS filtering component 260a or the host DFS filtering component 260b (whichever one is handling the DFS filtering) may generate and send a radar indicator to a host DFS verifier 270. The radar indicator may indicate that a radar signal or signal representative of a radar system has been found in a particular frequency channel and, therefore, an alternative frequency channel may need to be used instead by the wireless device. If such characteristics or signatures are insufficient (e.g., if a strength level of a pulse or signal associated with a radar-generated transmission is less than a threshold value) or not detected at all, then the target DFS filtering component 260a or the host DFS filtering component 260b (whichever one is handling the DFS filtering) may not generate and send a radar indicator to the host DFS verifier 270, or may generate and send a radar indicator indicating that a radar signal or signal representative of a radar system has not been found in a particular frequency channel and, therefore, that frequency channel may be used or may continue to be used by the wireless device.

The host DFS verifier 270 may, based on the radar indicator received from either the target DFS filtering component 260a or the host DFS filtering component 260b, generate and send a radar event to the host software 220, where the radar event may indicate that a radar signal or signal representative of a radar system has been found and, therefore, the host software 220 may take the appropriate steps to move WLAN communications to a suitable frequency channel that will not interfere with the radar system.

The host DFS verifier 270 may also be used to verify that the host DFS filtering component 260b is secure, that is, that the host DFS filtering component 260b has not been interfered, tampered, or otherwise altered without authorization. For example, the host DFS verifier 270 may generate and send a signal to the DFS pulse generator 280 to generate one or more DFS pulses. These DFS pulses are synthetically generated, that is, they are not real DFS pulses received by the wireless device, but are instead simulated or fake pulses that include characteristics or signatures similar to those found in radar-generated transmissions. These DFS pulses are sent to the host DFS filtering component 260b through the load balancer 250 as part of a verification procedure. If the host DFS filtering component 260b upon processing the simulated DFS pulses generated by the DFS pulse generator 280 returns a radar indicator that indicates the presence of a radar signal, then the host DFS verifier 270 confirms or verifies that the host DFS filtering component 260b is operating properly and is secure (e.g., has not been tampered with). On the other hand, if the host DFS filtering component 260b upon processing the simulated DFS pulses generated by the DFS pulse generator 280 returns a radar indicator that indicates that a radar signal is not present or does not return a radar indicator at all, then the host DFS verifier 270 confirms or verifies that the host DFS filtering component 260b is not operating properly and is not secure (e.g., may have been tampered with). In this case, the host DFS verifier 270 may only generate and send radar events in response to a radar indictor from the target DFS filtering component 260a. In another aspect, the host DFS verifier 270 may indicate or convey to the load balancer 250 that the host DFS filtering component 260b has been compromised and is not to be selected for DFS filtering.

FIG. 3A illustrates diagrams 300 and 320 that show an example of load balancing between the host software 220 and the firmware 235. In this example, the load balancer 250 in FIG. 2B may take into consideration load metrics to determine whether to switch DFS filtering between the target DFS filtering component 260a and the host DFS filtering component 260b.

As shown in the diagram 300, a host load metric 310 (solid line) and a target load metric 315 (dashed line) may be dynamic, that is, they vary over time. The load balancer 250 may determine to switch DFS filtering between the target DFS filtering component 260a in the firmware 235 and the host DFS filtering component 260b in the host software 220 based on values of the host load metric 310 and the target load metric 315. In the example shown in diagram 300, when a value of the target load metric 315 increases (e.g., the target processor 231 is becoming more heavily loaded—increased CPU cycle utilization) and is greater than a value of the host load metric 310, then the load balancer 250 may determine to switch from having DFS filtering being performed by the target DFS filtering component 260a (e.g., by the firmware 235) to being performed by the host DFS filtering component 260b (e.g., by the host software 220). This occurs at times t₁, t₃, and t₅ in the diagram 300.

When a value of the target load metric 315 decreases (e.g., the target processor 231 is becoming more lightly loaded—decreased CPU cycle utilization) and is less than a value of the host load metric 310, then the load balancer 250 may determine to switch from having DFS filtering being performed by the host DFS filtering component 260b (e.g., by the host software 220) to being performed by the target DFS filtering component 260a (e.g., by the firmware 235). This occurs at times t₂ and t₄ in the diagram 300.

The diagram 370 reflects the changes or switching in DFS filtering between the target DFS filtering component 260a (e.g., DFS processing by the target firmware or firmware 235) and the host DFS filtering component 260b (e.g., DFS processing by the host software 220). As shown, DFS filtering is performed by the target firmware or firmware 235 during periods 330 that occur before t₁, between t₂ and t₃, and between t₄ and t₅. DFS filtering is performed by the host software 220 during periods 335 that occur between t₁ and t₂, between t₃ and t₄, and after t₅.

FIG. 3B illustrates diagrams 350 and 370 that show an example of load balancing between the host software 220 and the firmware 235. In this example, the load balancer 250 in FIG. 2B may take into consideration load metrics and threshold values to determine whether to switch DFS filtering between the target DFS filtering component 260a and the host DFS filtering component 260b.

As shown in the diagram 350, the target load metric 315 (dashed line) may be dynamic, that is, the target load metric 315 varies over time. The load balancer 250 may determine to switch DFS filtering between the target DFS filtering component 260a in the firmware 235 and the host DFS filtering component 260b in the host software 220 based on values of the target load metric 315 and a threshold value 360 (solid line). Although shown as being constant, the threshold value 360 may also be dynamic, that is, the threshold value 360 varies over time. In an example, the threshold value 360 corresponds to the value of the host load metric 310 in FIG. 3A; however, the threshold value 360 need not be so limited and may correspond to other performance metrics or predetermined values. The threshold value 360 may be programmable and may be stored in the load balancer 250 or may be obtained by the load balancer 250 from the firmware 235 or from the host software 220.

In the example in the diagram 350, when a value of the target load metric 315 increases (e.g., the target processor 231 is becoming more heavily loaded—increased CPU cycle utilization) and is greater than the threshold value 360, the load balancer 250 may determine to switch from having DFS filtering being performed by the target DFS filtering component 260a (e.g., by the firmware 235) to being performed by the host DFS filtering component 260b (e.g., by the host software 220). This occurs at times t₁, t₃, and t₅ in the diagram 300.

When a value of the target load metric 315 decreases (e.g., the target processor 231 is becoming more lightly loaded—decreased CPU cycle utilization) and is less than the threshold value 360, the load balancer 250 may determine to switch from having DFS filtering being performed by the host DFS filtering component 260b (e.g., by the host software 220) to being performed by the target DFS filtering component 260a (e.g., by the firmware 235). This occurs at times t₂ and t₄ in the diagram 350.

The diagram 370 reflects the changes or switching in DFS filtering between the target DFS filtering component 260a (e.g., DFS processing by the target firmware or firmware 235) and the host DFS filtering component 260b (e.g., DFS processing by the host software 220). As shown, DFS filtering is performed by the target firmware or firmware 235 during periods 330 that occur before t₁, between t₂ and t₃, and between t₄ and t₅. DFS filtering is performed by the host software 220 during periods 335 that occur between t₁ and t₂, between t₃ and t₄, and after t₅.

The concepts described above with respect to FIGS. 3A and 3B may be considered together. That is, the load balancer 250 may take into consideration not only the target processor metric 315 and the host processor metric 310 but may also take into consideration a threshold value that may be used as an offset when comparing the target processor metric 315 and the host processor metric 310. For example, in the diagram 300 at t₁, the load balancer 250 may switch the DFS processing from the target DFS filtering component 260a (e.g., by target firmware) to the host DFS filtering component 260b (e.g., by host software) as soon as the value of the target processor metric 315 (e.g., the load of the target processor 231) is greater than the value of the host processor metric 310 (e.g., the load of the host processor 216). At this point the loads on the firmware and the host are similar. By introducing an offset (e.g., a threshold value), it may be possible to have the load balancer 250 make the switch at a time when there is sufficiently processing capability available in the component to which the DFS processing is going to be moved.

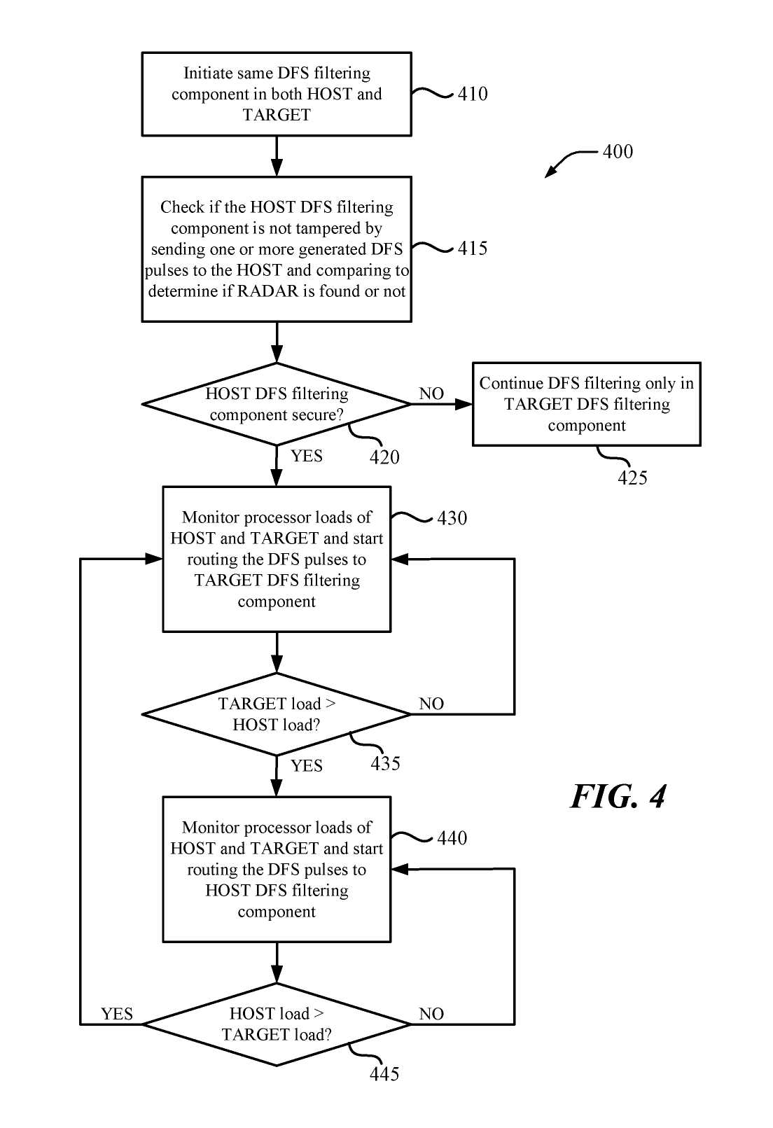

FIG. 4 shows a flow diagram illustrating an example of a method 400 for secure and distributed DFS. Aspects of the method 400 may be performed by the host hardware 215, the target hardware 230, and/or the DFS component 610 described below in connection with FIG. 6.

At 410, the same DFS filtering (e.g., DFS pulse filtering algorithm) is initiated in both the host and the target. That is, the target DFS filtering component 260a is initiated (e.g., configured, enabled, started) in the firmware 235 and the host DFS filtering component 260b is initiated (e.g., configured, enabled, started) in the host software 220. The initiation may be coordinated by the host software 220, for example, although both the host software 220 and the firmware 235 may be involved in the initiation process. While both the target DFS filtering component 260a and the host DFS filtering component 260b are initiated, the target DFS filtering component 260a is typically selected to be the one that is initially used.

At 415, the host DFS filtering component 260b is checked or verified to ensure that it has not been tampered with by sending one or more generated (e.g., simulated) DFS pulses to the host and comparing the DFS pulses (e.g., processing or filtering the DFS pulses) to determine if a radar signal is found or not in connection with the DFS pulses. That is, as described above in FIG. 2B, the host DFS verifier 270 may control or signal to the DFS pulse generator 280 to generate and send or forward one or more simulated or synthetic DFS pulses to the host DFS filtering component 260b for processing (e.g., filtering). The DFS pulses may include characteristics or signatures found in a radar signal. The DFS pulses generated by the DFS pulse generator 280 may therefore be simulated or synthetic signals identifying radar communications. If the host DFS filtering component 260b indicates that a radar signal is found after processing the one or more DFS pulses, then the host DFS verifier 270 may confirm that the host DFS filtering component 260b is secured and has not been tampered with. If on the other hand the host DFS filtering component 260b indicates that a radar signal has not been found after processing the one or more DFS pulses, then the host DFS verifier 270 may confirm that the host DFS filtering component 260b is not secured and may have been tampered with.

At 420, a determination is made on whether the host DFS filtering component 260b is secure. If it is not secure (as determined by the host DFS verifier 270, for example), then the method 400 may proceed to 425 in which only the target DFS filtering component 260a is continued to be used for DFS filtering or DFS processing. If it is secure, then the method 400 may proceed to 430.

At 430, processor loads may be monitored for the host and target and DFS pulses are first routed to the target DFS filtering component 260a. That is, the load balancer 250 may initially send any DFS pulses received from the target hardware 230 to the target DFS filtering component 260a. The load balancer 250 may monitor the target load metrics and/or the host load metrics (see e.g., FIG. 3A) to make a determination on whether to continue to have DFS filtering performed by the target DFS filtering component 260a or instead switch DFS filtering to be performed by the host DFS filtering component 260b. As noted above, if the host processor (e.g., the host processor 216) is not available (e.g., because of a power save mode or sleep mode) and the target processor (e.g., the target processor 231) is not heavily loaded, then the load balancer 250 may continue performing DFS filtering by the target DFS filtering component 260a. If the host processor is available (and secure) and the target processor is heavily loaded, then the then the load balancer 250 may switch DFS filtering to the host DFS filtering component 260b.

At 435, a determination is made on whether a target load (e.g., the target load metric 315) is greater than a host load (e.g., the host load metric 310). If the target load is greater, then the method 400 may proceed to 440; otherwise, the method 400 may return to 430 to continue monitoring the processor loads. At 440, the DFS pulses are routed to the host DFS filtering component 260b and the processor loads are continued to be monitored.

At 445, a determination is made on whether the host load is greater than the target load. If the host load is greater, then the method 400 may return to 430; otherwise, the method 400 may return to 440 to continue monitoring the processor loads.

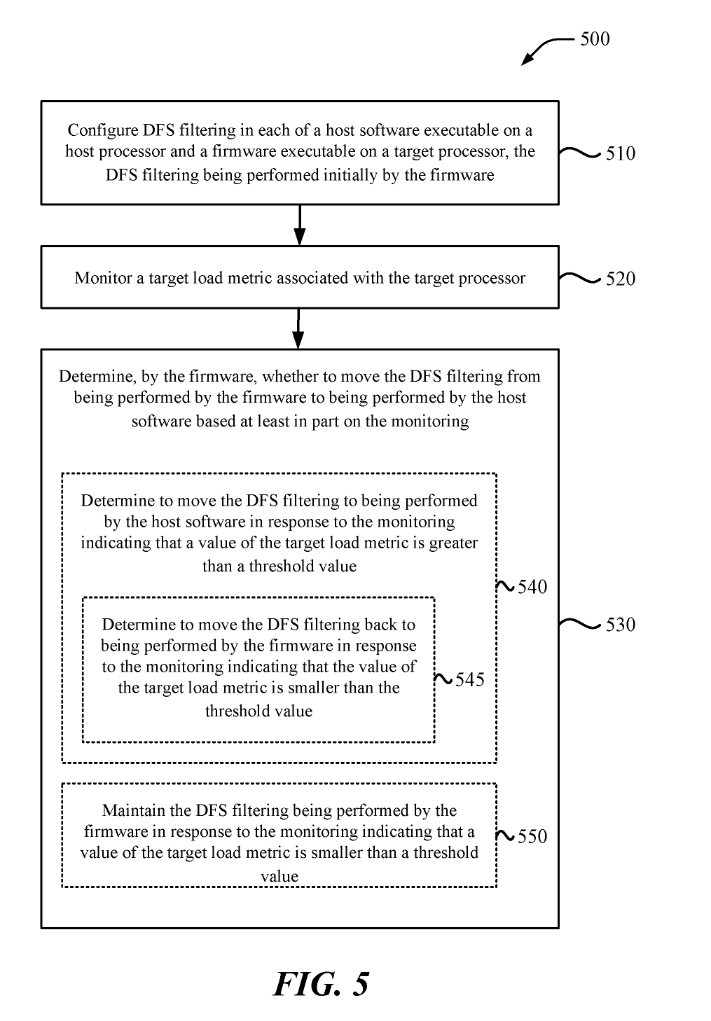

FIG. 5 is a flow diagram illustrating an example of a method 500. Aspects of the method 500 may be performed by one or more of the components shown in FIGS. 2A, 2B, and 6. For example, aspects of the method 500 may be performed by the host hardware 215, the target hardware 230, processor(s) 612, a modem 614, the DFS component 610, and/or any of the subcomponents of the DFS component 610 including a configuration component 615, a monitoring component 620, and a filtering selection component 630.

At 510, the method 500 includes configuring DFS filtering in each of a host software (e.g., the host software 220) executable on a host processor (e.g., the host processor 216 in the host hardware 215) and a firmware (e.g., the target software/firmware 235) executable on a target processor (e.g., the target processor 231 in the target hardware 230), where the DFS filtering is performed initially by the firmware (see e.g., 430 in the method 400). In an aspect, the configuring may be performed by the host processor, the target processor, or both.

At 520, the method 500 includes monitoring a target load metric (e.g., the target processor metric or target load metric 315) associated with the target processor. In an aspect, the load balancer 250 may receive the target load metric from the target (e.g., from the target processor 231) and may compare, as part of the monitoring, the target load metric to a host load metric (e.g., the host processor metric or host load metric 310) associated with the host processor and/or to a threshold value.

At 530, the method 500 includes determining, by the firmware, whether to move DFS filtering from being performed by the firmware (e.g., by the target DFS filtering component 260a) to being performed by the host software (e.g., by the host DFS filtering component 260b) based at least in part on the monitoring. That is, the load balancer 250 in the firmware 235 may make a determination, based on the inputs received and monitored, as to whether to have DFS filtering done by the target DFS filtering component 260a or by the host DFS filtering component 260b.

At 540, in 530, the method 500 includes determining (e.g., by the load balancer 250) to move DFS filtering to being performed by the host software in response to the monitoring indicating that a value of the target load metric is greater than a threshold value (see e.g., 435 and 440 in the method 400). In an aspect, the threshold value may be dynamic and vary over time. In another aspect, the threshold value may correspond to a value of a host load metric associated with the host processor. Moreover, the target load metric may indicate a level of utilization of the target processor and the host load metric may indicate a level of utilization of the host processor.

At 545, in 540, the method 500 includes determining to move DFS filtering back to being performed by the firmware in response to the monitoring indicating that the value of the target load metric is smaller than the threshold value (see e.g., 445 and 430 in the method 400).

At 550, in 530, the method 500 includes maintaining or continuing DFS filtering being performed by the firmware in response to the monitoring indicating that a value of the target load metric is smaller than a threshold value (see e.g., 425 in the method 400).

In an aspect, the method 500 may also include determining whether performing DFS filtering by the host software is secure (e.g., by the host DFS verifier 270 with the DFS pulse generator 280). As such, DFS filtering may be maintained or continued to be performed by the firmware in response to a determination that performing DFS filtering by the host software is insecure. Moreover, determining whether performing DFS filtering by the host software is secure includes generating, at the firmware, a signal identifying radar communications (e.g., generating one or more DFS pulses with radar characteristics or signatures), forwarding the signal to the host software for performing DFS filtering by the host software, and receiving, at the firmware, an indication (e.g., the radar indicator) from the host software of whether radar communications were detected from the signal, the indication resulting from performing DFS filtering by the host software.

FIG. 6 describes hardware components and subcomponents of a wireless device (e.g., STA 115) for implementing techniques for secure and distributed DFS as described by this disclosure. For example, an implementation of the STA 115 (e.g., a laptop computer illustrated by STA2 115-b) may include a variety of components, including components such as the processors 612, the memory 616, the transceiver 602, and the modem 614 in communication via one or more buses 644. In an aspect, the processors 612 may include the modem 614 that may use one or more modem processors.

The STA 115 in FIG. 6 may also include a WLAN card 625, which may be an example of the WLAN card 225 described above in connection with FIG. 2A. The WLAN card 625 may be in communication with other components of the STA 115 (e.g., the processors 612) via the one or more buses 644. The WLAN card 625 may be integrated with the STA 115 or may be removably coupled to the STA 115. As shown in the example of FIG. 6, the WLAN card 625 may use the transceiver 602, the RF front end 688, and the antennas 665 for WLAN communications. In a different example, the transceiver, RF front end, and/or antennas used by the WLAN card 625 for WLAN communications may be integrated into the WLAN card 625 and may be different from the transceiver 602, the RF front end 688, and/or the antennas 665.

The WLAN card 625 may include the DFS component 610 to enable one or more of the functions described herein as well as one or more methods (e.g., the method 400, the method 500) of the disclosure for secure and distributed DFS.

The various functions related to the DFS component 610 may be included in the WLAN card 625 and/or the processors 612 and, in an aspect, may be executed by a single processor, while in other aspects, different ones of the functions may be executed by a combination of two or more different processors. For example, in an aspect, the processors 612 may include any one or any combination of a modem processor, or a baseband processor, or a digital signal processor, or a transmit processor, or a receiver processor, or a transceiver processor associated with the transceiver 602. In other aspects, some of the features of the DFS component 610 and/or the one or more processors 612 may be performed by the transceiver 602.

Also, the memory 616 may be configured to store data or applications used in connection with the DFS component 610 and/or one or more of its subcomponents. The WLAN card 625 may also include a memory (not shown) configured to store data or applications used in connection with the DFS component 610. The memory 616 may include any type of computer-readable medium usable by a computer or at least one processor 612, such as random access memory (RAM), read only memory (ROM), tapes, magnetic discs, optical discs, volatile memory, non-volatile memory, and any combination thereof In an aspect, for example, the memory 616 may be a non-transitory computer-readable storage medium that stores one or more computer-executable codes.

The transceiver 602 may include at least one receiver 606 and at least one transmitter 608. The receiver 606 may include hardware, firmware, and/or software code executable by a processor for receiving data, the code comprising instructions and being stored in a memory (e.g., computer-readable medium). The receiver 606 may be, for example, a radio frequency (RF) receiver. In an aspect, the receiver 606 may receive signals transmitted by at least one wireless communications device (e.g., AP 105, another STA 115, or a source of radar signals). Additionally, the receiver 606 may process such received signals, and also may obtain measurements of the signals, such as, but not limited to, Ec/Io, SNR, RSRP, RSSI, etc. The transmitter 608 may include hardware, firmware, and/or software code executable by a processor for transmitting data, the code comprising instructions and being stored in a memory (e.g., computer-readable medium). A suitable example of the transmitter 608 may include, but is not limited to, an RF transmitter.

Moreover, in an aspect, the wireless device or STA 115 may include the RF front end 688 mentioned above, which may operate in communication with the one or more antennas 665 and the transceiver 602 for receiving and transmitting radio transmissions. The RF front end 688 may be connected to the one or more antennas 665 and may include one or more low-noise amplifiers (LNAs) 690, one or more switches 692, one or more power amplifiers (PAs) 698, and one or more filters 696 for transmitting and receiving RF signals.

In an aspect, the LNA 690 can amplify a received signal at a desired output level. In an aspect, each LNA 690 may have a specified minimum and maximum gain values. In an aspect, the RF front end 688 may use the one or more switches 692 to select a particular LNA 690 and its specified gain value based on a desired gain value for a particular application.

Further, for example, the one or more PA(s) 698 may be used by the RF front end 688 to amplify a signal for an RF output at a desired output power level. In an aspect, each PA 698 may have specified minimum and maximum gain values. In an aspect, the RF front end 688 may use the one or more switches 692 to select a particular PA 698 and its specified gain value based on a desired gain value for a particular application.

Also, for example, the one or more filters 696 may be used by the RF front end 688 to filter a received signal to obtain an input RF signal. Similarly, in an aspect, for example, a respective filter 696 can be used to filter an output from a respective PA 698 to produce an output signal for transmission. In an aspect, each filter 696 can be connected to a specific LNA 690 and/or PA 698. In an aspect, the RF front end 688 can use one or more switches 692 to select a transmit or receive path using a specified filter 696, LNA 690, and/or PA 698, based on a configuration as specified by the transceiver 602 and/or the processors 612.

As such, the transceiver 602 may be configured to transmit and receive wireless signals through the one or more antennas 665 via the RF front end 688. In an aspect, the transceiver 602 may be tuned to operate at specified frequencies. In an aspect, for example, the modem 614 can configure the transceiver 602 to operate at a specified frequency (e.g., specified frequency channel) and power level based on the configuration of the wireless device or STA 115 and the communication protocol used by the modem 614.

In an aspect, the modem 614 can be a multiband-multimode modem, which can process digital data and communicate with the transceiver 602 such that the digital data is sent and received using the transceiver 602. In an aspect, the modem 614 can be multiband and be configured to support multiple frequency bands for a specific communications protocol. In an aspect, the modem 614 can be multimode and be configured to support multiple operating networks and communications protocols. In an aspect, the modem 614 may control one or more components of wireless device or STA 115 (e.g., the RF front end 688, the transceiver 602) to enable transmission and/or reception of signals based on a specified modem configuration. In an aspect, the modem configuration may be based on the mode of the modem and the frequency band or channel in use. In another aspect, the modem configuration may be based on STA configuration information associated with wireless device or STA 115.

The DFS component 610 may include the configuration component 615, the monitoring component 620, and the filtering selection component 630, as described above.

In an example, the configuration component 615 may be implemented by or be part of the DFS component 610 as shown in FIG. 6. In another example, the configuration component 615 may be implemented by or be part of the processors 612. In yet another example, the configuration component 615 may be implemented by or be part of the DFS component 610 and the processors 612.

The configuration component 615 may configure DFS filtering in each of a host software executable on a host processor and a firmware executable on a target processor, where DFS filtering may be performed initially by the firmware.

In an aspect, the host processor may refer to the processors 612, which may correspond to the host processors 216 in FIG. 2A. The host software may refer to code executable on the processors 612, and may correspond to the host software 220 in FIG. 2A. Moreover, the memory 616 may correspond to the host memories 217 in FIG. 2A.

In another aspect, the target processor may refer a processor (not shown) in the WLAN card 625, which may correspond to the target processors 231 in the WLAN card 225 in FIG. 2A. The target software or firmware may refer to code executable on the processor in the WLAN card 625, which may correspond to the target software/firmware 235 in FIG. 2. Moreover, a memory (not shown) in the WLAN card 625 may correspond to the memories 232 in FIG. 2A.

The monitoring component 620 may monitor a target load metric associated with the target processor. In an aspect, the monitoring component 620 may perform functions or include features that correspond to those of the load balancer 250 described above. As such, the monitoring component 620 may also consider a host load metric and/or a threshold value in connection with its monitoring operations. Thus, the monitoring component 620 may monitor one or more values 623, include target load metrics, host load metrics, and/or thresholds or offsets.

The filtering selection component 630 may determine whether to move DFS filtering from being performed by the firmware to being performed by the host software based at least in part on the monitoring. In an aspect, the filtering selection component 630 may perform functions or include features that correspond to those of the load balancer 250 described above. As such, the filtering selection component 630 may select or switch between DFS filtering in the host software (e.g., the host DFS filtering component 260b) and DFS filtering in the firmware (e.g., the target DFS filtering component 260a) based on the inputs monitored by the monitoring component 620. The filtering selection component 630 may include a switching component 633 to coordinate the switching of the DFS filtering between the host software and the firmware.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for.”

What is claimed is:

1. A method for distributed dynamic frequency selection (DFS), comprising:
configuring DFS filtering in each of a host software executable on a host processor and a firmware executable on a target processor, the DFS filtering being performed initially by the firmware;
monitoring a target load metric associated with the target processor; and
determining, by the firmware, whether to move the DFS filtering from being performed by the firmware to being performed by the host software based at least in part on the monitoring.

2. The method of claim 1, wherein the target load metric indicates a level of utilization of the target processor.

3. The method of claim 1, wherein determining whether to move the DFS filtering from being performed by the firmware to being performed by the host software comprises:
determining to move the DFS filtering from being performed by the firmware to being performed by the host software in response to the monitoring indicating that a value of the target load metric is greater than a threshold value.

4. The method of claim 3, wherein the threshold value varies over time.

5. The method of claim 3, wherein the threshold value corresponds to a value of a host load metric associated with the host processor.

6. The method of claim 5, wherein the host load metric indicates a level of utilization of the host processor.

7. The method of claim 3, further comprising:
determining to move the DFS filtering from being performed by the host software back to being performed by the firmware in response to the monitoring indicating that the value of the target load metric is smaller than the threshold value.

8. The method of claim 1, wherein determining whether to move the DFS filtering from being performed by the firmware to being performed by the host software comprises:
maintaining the DFS filtering being performed by the firmware in response to the monitoring indicating that a value of the target load metric is smaller than a threshold value.

9. The method of claim 1, further comprising:
determining whether performing the DFS filtering by the host software is secure,
wherein determining whether to move the DFS filtering from being performed by the firmware to being performed by the host software comprises maintaining the DFS filtering being performed by the firmware in response to a determination that performing the DFS filtering by the host software is insecure.

10. The method of claim 9, wherein determining whether performing the DFS filtering by the host software is secure comprises:
generating, at the firmware, a signal identifying radar communications;
forwarding the signal to the host software for performing the DFS filtering by the host software; and
receiving, at the firmware, an indication from the host software of whether radar communications were detected from the signal, the indication resulting from performing the DFS filtering by the host software.

11. A wireless communications device for distributed dynamic frequency selection (DFS), comprising:
a memory storing instructions; and
one or more processors including a target processor, wherein the one or more processors are configured to:
configure DFS filtering in each of a host software executable on a host processor and a firmware executable on the target processor, the DFS filtering being performed initially by the firmware;
monitor a target load metric associated with the target processor; and
determine, by the firmware, whether to move the DFS filtering from being performed by the firmware to being performed by the host software based at least in part on the monitoring.

12. The wireless communications device of claim 11, wherein the one or more processors configured to determine whether to move the DFS filtering from being performed by the firmware to being performed by the host software are configured to:
determine to move the DFS filtering from being performed by the firmware to being performed by the host software in response to the monitoring indicating that a value of the target load metric is greater than a threshold value.

13. The wireless communications device of claim 12, wherein the threshold value varies over time.

14. The wireless communications device of claim 12, wherein the threshold value corresponds to a value of a host load metric associated with the host processor.

15. The wireless communications device of claim 14, wherein:
the target load metric indicates a level of utilization of the target processor, and
the host load metric indicates a level of utilization of the host processor.

16. The wireless communications device of claim 12, wherein the one or more processors are further configured to:
determine to move the DFS filtering from being performed by the host software back to being performed by the firmware in response to the monitoring indicating that the value of the target load metric is smaller than the threshold value.

17. The wireless communications device of claim 11, wherein the one or more processors configured to determine whether to move the DFS filtering from being performed by the firmware to being performed by the host software are configured to:
maintain the DFS filtering being performed by the firmware in response to the monitoring indicating that a value of the target load metric is smaller than a threshold value.

18. The wireless communications device of claim 11, wherein the one or more processors are further configured to:
determine whether performing the DFS filtering by the host software is secure, and
wherein the one or more processors configured to determine whether to move the DFS filtering from being performed by the firmware to being performed by the host software are configured to maintain the DFS filtering being performed by the firmware in response to a determination that performing the DFS filtering by the host software is insecure.

19. The wireless communications device of claim 11, wherein the one or more processors configured to determine whether performing the DFS filtering by the host software is secure are configured to:
generate, at the firmware, a signal identifying radar communications;
forward the signal to the host software for performing the DFS filtering by the host software; and
receive, at the firmware, an indication from the host software of whether radar communications were detected from the signal, the indication resulting from performing the DFS filtering by the host software.

20. A computer-readable medium storing code executable by one or more processors for distributed dynamic frequency selection (DFS), comprising:
code for configuring DFS filtering in each of a host software executable on a host processor and a firmware executable on a target processor, the DFS filtering being performed initially by the firmware;
code for monitoring a target load metric associated with the target processor; and
code for determining, by the firmware, whether to move the DFS filtering from being performed by the firmware to being performed by the host software based at least in part on the monitoring.
